(19) United States
(12) Patent Application Publication
(10) Pub. No.: US 2014/0300043 A1
(43) Pub. Date: Oct. 9, 2014

(54) FILM ALIGNMENT DEVICE

(71) Applicant: SAMSUNG DISPLAY CO., LTD., Yongin-City (KR)

(72) Inventor: Wook Yeon JUNG, Yongin-City (KR)

(73) Assignee: SAMSUNG DISPLAY CO., LTD., Yongin-City (KR)

(21) Appl. No.: 14/016,532

(22) Filed: Sep. 3, 2013

(30) Foreign Application Priority Data
Apr. 4, 2013 (KR) 10-2013-0036717

(51) Int. Cl. B23Q 3/18

(52) U.S. Cl. CPC B23Q 3/186
USPC 269/289 R

(57) ABSTRACT

A film alignment device includes a stage on which a film is disposed and an alignment body above the stage, the alignment body and the stage being spaceable apart from and facing each other. The stage includes a plurality of guide parts at sides thereof. The alignment body includes a plurality of pins configured to move in the guide parts to align the film.

### CROSS-REFERENCE TO RELATED APPLICATIONS

Korean Patent Application No. 10-2013-0036717, filed on Apr. 4, 2013, with the Korean Intellectual Property Office, is incorporated herein in its entirety by reference.

### TECHNICAL FIELD

Embodiments relate to a film alignment device, and more particularly, to a film alignment device capable of finely arranging a thin flexible film used in an organic light emitting display device by using a plurality of pins.

### BACKGROUND

An organic light emitting display device is a self-emission display device which has an organic light emitting diode that emits light to display an image. Since the organic light emitting display device does not require a separate light source unlike a liquid crystal display, it is possible to relatively reduce a thickness and a weight thereof, and there are advantages such as low power consumption, high luminance, and rapid response speed.

The organic light emitting display device includes a hole injection electrode, an organic emission layer, an electron injection electrode, and a thin film encapsulation layer, and a substrate.

### SUMMARY

Embodiments are directed to a film alignment device including a stage on which a film is disposed and an alignment body above the stage, the alignment body and the stage being spaceable apart from and facing each other. The stage includes a plurality of guide parts at sides thereof. The alignment body includes a plurality of pins configured to move in the guide parts to align the film.

The guide parts may have groove shapes that are spaced apart from each other at the side of the stage.

An alignment area may be defined in the stage. Ends of the grooves may correspond to the alignment area.

The cross section of the pins may be a circle, an oval, or a polygon.

The alignment body may include a movable panel part. The plurality of pins may be included in the movable panel part.

The alignment body may include drivers for driving the movable panel part.

The alignment body may include a detector that recognizes a position of the film.

The alignment body may include a controller that controls the alignment means.

The pins may reciprocate. The pins may reciprocate such that the pins move and vibrate in the guide parts.

The alignment body may include a plurality of suction holes.

The movable panel part may include a plurality of suction holes.

The stage may include a plurality of suction holes to fix the film.

Embodiments are also directed to an alignment device including a stage on which a sheet to be aligned is disposed, the stage including guide parts at sides thereof, and an alignment body above the stage, the alignment body and the stage being spaceable apart from and facing each other, and the alignment body including pins that move in the guide parts.

The sheet to be aligned is a film. The film has flexibility.

An alignment area may be defined in the stage.

The alignment device may be configured such that when the sheet deviates from the alignment area, the sheet is aligned by driving pins corresponding to a position of deviation.

The alignment body may include a detector that recognizes a position of the sheet.

### BRIEF DESCRIPTION OF THE DRAWINGS

FIG. 1 is a perspective view schematically illustrating main constituent elements of a film alignment device according to a first exemplary embodiment.

FIG. 2 is a diagram illustrating a stage according to the first exemplary embodiment.

FIG. 3 is a diagram illustrating an alignment body according to the first exemplary embodiment.

FIG. 4 is a diagram illustrating a control of the alignment body according to the first exemplary embodiment.

FIG. 5 is a diagram illustrating an operational state of pins according to the first exemplary embodiment.

FIG. 6 is a diagram illustrating an alignment body according to a second exemplary embodiment.

FIG. 7 is a diagram illustrating a control of the alignment body according to the second exemplary embodiment.

FIG. 8 is a plan view illustrating an alignment body according to a third exemplary embodiment.

FIG. 9 is a diagram illustrating a moving state of a film carrying part according to the third exemplary embodiment.

### DETAILED DESCRIPTION

Hereinafter, exemplary embodiments will be described in more detail with reference to the accompanying drawings. However, the scope is not limited to the following Examples and drawings. Contents to be described below and exemplary embodiments illustrated in the drawings may include various equivalences and modifications.

The terminologies used in this specification are terms used in order to express the exemplary embodiments and may depend on the intention of users or operators or the custom in the art to which the present disclosure belongs. Accordingly, the terminologies need to be defined based on contents throughout this specification.

For reference, respective components and shapes thereof are schematically drawn or exaggeratedly drawn in the accompanying drawings for easy understanding. Elements having the same function are represented by like reference numerals in the drawings.

It will be understood that when a layer or an element is described as being “on” another layer or element, it may be directly disposed on another layer or element, or an intervening layer or element may also be present.

### First Exemplary Embodiment

In the first exemplary embodiment, an alignment body 200 exemplifies a film alignment device including a plurality of pins 211, 221, 231, and 241, and a plurality of panels 210, 220, 230, and 240.

The term “panel part” refers to the plurality of panels 210, 220, 230, and 240.

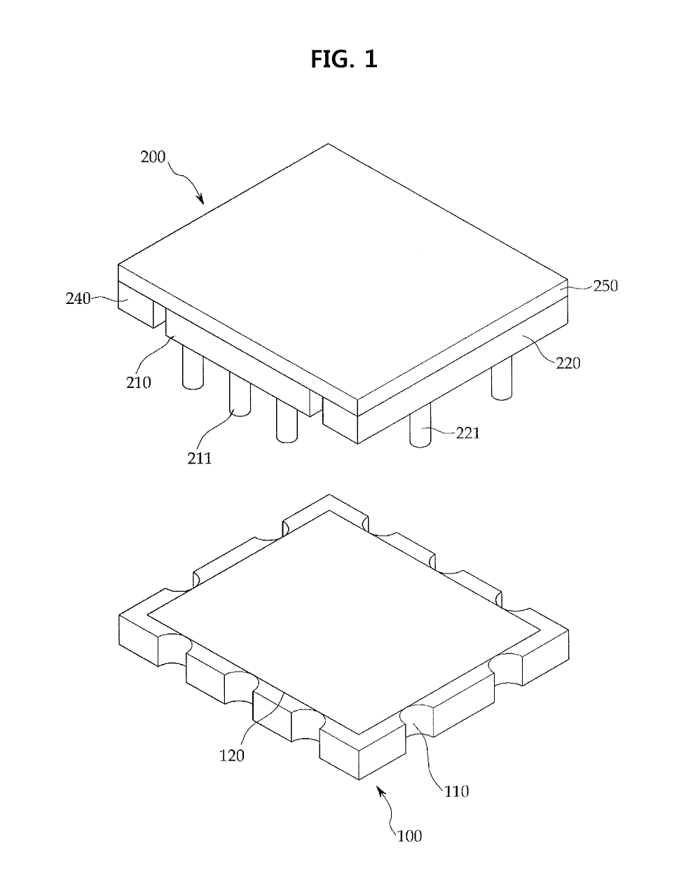

FIG. 1 is a perspective view schematically illustrating main constituent elements of a film alignment device according to the first exemplary embodiment.

Referring to FIG. 1, the film alignment device according to the first exemplary embodiment includes a stage 100 and an alignment body 200. The alignment body 200 is separately disposed above the stage 100, and the alignment body 200 may ascend and descend to the stage 100. Guide parts 110 included in the stage 100 may be formed at positions corresponding to the pins 211, 221, 231, 241 included in the alignment body 200. That is, the pins 211, 221, 231, and 241 are positioned above the guide parts 110 before the alignment body 200 descends, and when the alignment body 200 descends and then an alignment operation is performed, the pins 211, 221, 231, and 241 may be positioned inside the guide parts 110.

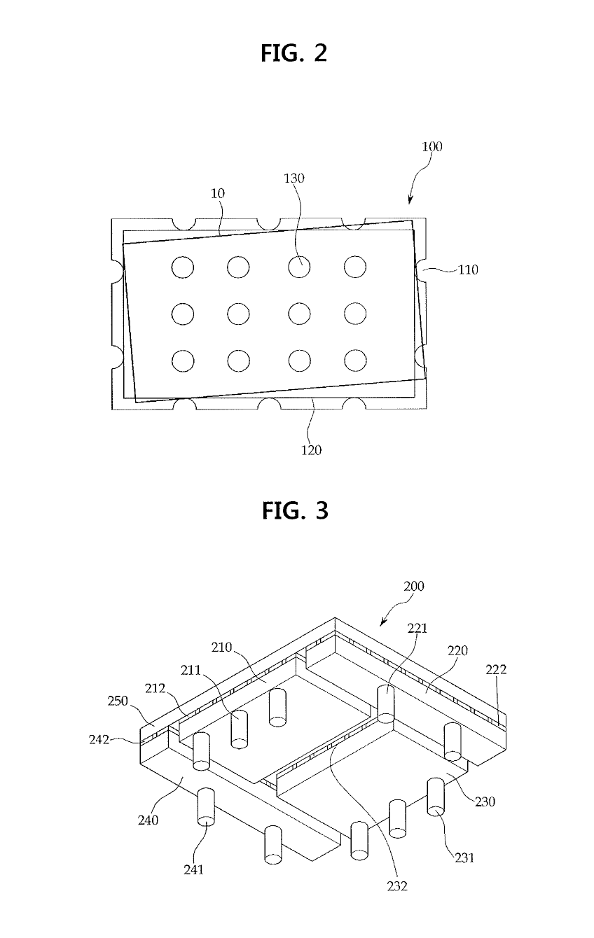

FIG. 2 is a diagram illustrating a stage according to the first exemplary embodiment. Referring to FIG. 2, the stage 100 includes the guide parts 110 and an alignment area 120, and may further include stage suction holes 130.

A film 10 is disposed at the stage 100. The alignment area 120 may be defined at the stage 100. The term “alignment area” 120 refers to an area from which the film 10 does not deviate when the alignment of the film 10 is accurately performed. That is, when the film wholly enters into the alignment area 120, it is determined that the alignment is performed. Accordingly, when the film 10 deviates from the alignment area 120, the film 10 is considered as misaligned. As illustrated in FIG. 2, when the film 10 is misaligned with the alignment area 120, the alignment is performed by the alignment body 200.

The stage 100 includes the guide parts 110 at the side. The guide parts 110 are formed at the side of the stage 100 to be spaced apart from each other to have a groove shape. In FIGS. 1 and 2, a predetermined number of guide parts 110 are formed at four sides of the rectangular stage 100. The number of guide parts 110 do not necessarily coincide with the number illustrated in the drawing, and the number, and the guide parts 110 may be manufactured by modifying the number and the size of the guide parts 110 according to the need of those skilled in the art.

Ends of the grooves may be formed up to the alignment area 120. Accordingly, when some of the plurality of grooves are covered by the film 10, the film 10 may not be aligned. For example, as illustrated in FIG. 2, when the film 10 covers grooves positioned at the right side and the upper side of the stage 100, only the pins positioned at the corresponding grooves among the pins 211, 221, 231, and 241 of the alignment body 200 individually move and thus the alignment operation may be performed.

A plurality of stage suction holes 130 may be further included in the stage 100 to fix the film 10. A vacuum pump (not illustrated) may be connected to the stage suction holes 130. Vacuum suction does not operate in the stage suction holes 130 before alignment (before fixing). After the alignment of the film 10 is completed, the vacuum suction operates, and the aligned film is fixed to the alignment area 120 of the stage 100. Thereafter, an additional operation may be performed on the fixed film 10. For example, an operation may be performed, in which the film 10 moves, another material is laminated on the film 10, or a protective film and a release paper on the film are removed. The number and a layout position of the stage suction holes 130 are exemplified, and the number, the size, and the like of the stage suction holes 130 may be modified according to the need of those skilled in the art.

FIG. 3 is a diagram illustrating an alignment body according to the first exemplary embodiment. Referring to FIG. 3, the alignment body 200 includes panels 210, 220, 230, and 240, pins 211, 221, 231, and 241, rails 212, 222, 232, and 242, and an alignment substrate 250.

The alignment body 200 may be disposed above the stage 100. The alignment body 200 and the stage may be spaceable apart and facing each other. An alignment operation may be carried out by the panels 210, 220, 230, and 240, and the pins 211, 221, 231, and 241.

The alignment substrate 250 may be a rectangular wide plate, and may be manufactured as the same shape as the alignment area 120 so as to alignment the film 10.

The panel part may include a first panel 210, a second panel 220, a third panel 230, and a fourth panel 240. The panels 210, 220, 230, and 240 may include respective pins 211, 221, 231, and 241, and drivers 281, 282, 283, and 284. The panels 210, 220, 230, and 240 may move. For example, the panels 210, 220, 230, and 240 are controlled though the drivers 281, 282, 283, and 284, and connected to rails 212, 222, 232, and 242 so as to be moved. The panels 210, 220, 230, and 240 are aligned on the stage 100 to press and fix the disposed film 10. Accordingly, it may be possible to prevent the film from being lifted. The number and a layout position of the panels 210, 220, 230, and 240 are exemplified, and the number, the size, and the like of the panels 210, 220, 230, and 240 may be modified according to the need of those skilled in the art.

The pins 211, 221, 231, and 241 may be included on the panels 210, 220, 230, and 240. The pins 211, 221, 231, and 241 may be provided to move in the guide parts 110. Cross sections of the pins 211, 221, 231, and 241 may be circles, ovals, or polygons. The number and a layout position of the pins 211, 221, 231, and 241 are exemplified, and the number, the size, and the like of the pins 211, 221, 231, and 241 may be modified according to the need of those skilled in the art.

The rails 212, 222, 232, and 242 connect the alignment substrate 250 with the panels 210, 220, 230, and 240 and provide moving paths of the panels 210, 220, 230, and 240. The rails 212, 222, 232, and 242 may be configured by a first rail 212, a second rail 222, a third rail 232, and a fourth rail 242. The number and a layout position of the rails 212, 222, 232, and 242 are exemplified, and the number, the size, and the like of the rails 212, 222, 232, and 242 may be modified according to the need of those skilled in the art.

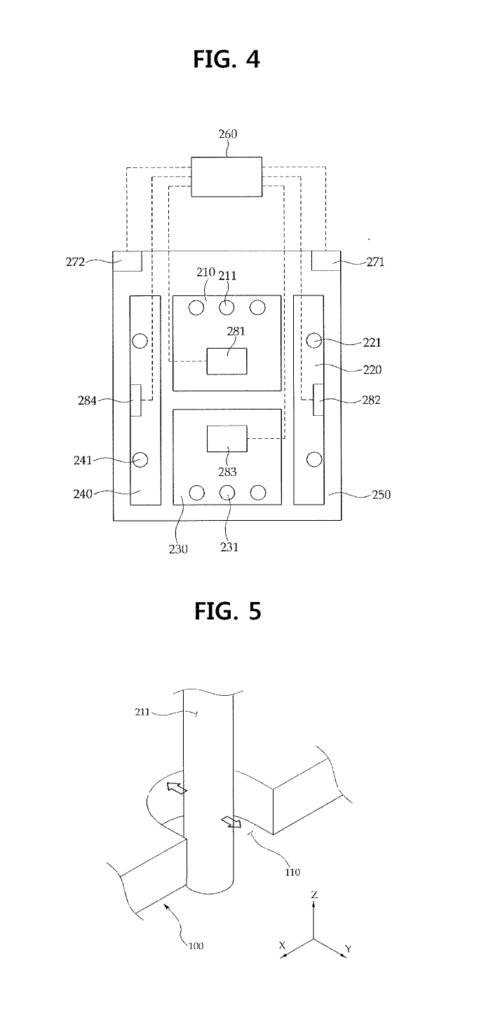

FIG. 4 is a diagram illustrating a control of the alignment body according to the first exemplary embodiment. Referring to FIG. 4, the alignment body 200 may further include a controller 260, detectors 271 and 272, and drivers 281, 282, 283, and 284.

The drivers 281, 282, 283, and 284 drive the panels 210, 220, 230, and 240 and the pins 211, 221, 231, and 241. The drivers 281, 282, 283, and 284 may be configured by a first driver 281, a second driver 282, a third driver 283, and a fourth driver 284.

The controller 260 controls the panels 210, 220, 230, and 240 and the pins 211, 221, 231, and 241.

The detectors 271 and 272 recognize a position of the film 10. The detectors 271 and 272 may be configured by a first detector 271 and a second detector 272.

The numbers and layout positions of the controllers 260, the detectors 271 and 272, and the drivers 281, 282, 283, and 284 are exemplified, and the numbers, the sizes, and the like of the controllers 260, the detectors 271 and 272, and the drivers 281, 282, 283, and 284 may be modified according to the desires of those skilled in the art.

A controlling method and movement of the panels 210, 220, 230, and 240 and the pins 211, 221, 231, and 241 will be described below by using the constituent elements.

As illustrated in FIG. 4, the drivers 281, 282, 283, and 284 are included in the panels 210, 220, 230, and 240 to drive the pins 211, 221, 231, and 241 and the panels 210, 220, 230, and 240. The panels 210, 220, 230, and 240 may be moved by using the rails 212, 222, 232, and 242. In detail, the first driver 281 is positioned in the first panel 210 to drive the first panel 210 and the first pin 211. The second driver 282 is positioned in the second panel 220 to drive the second panel 220 and the second pin 221. The third driver 283 is positioned in the third panel 230 to drive the third panel 230 and the third pin 231. The fourth driver 284 is positioned in the fourth panel 240 to drive the fourth panel 240 and the fourth pin 241.

The detectors 271 and 272 may be positioned at the edge of the alignment substrate 250, and may check whether the film 10 is accurately aligned in the alignment area 120. For example, the detectors 271 and 272 measure X-axial, Y-axial, and Z-axial lengths and angle values up to the edge of the alignment area 120 and the edge of the film 10 and compare the measured lengths and angle values with a reference value in the case of accurately aligning the film 10 to determine whether the film 10 is aligned. The values may be measured by using a sensor (not illustrated) such as a camera.

The controller 260 controls operations of the drivers 281, 282, 283, and 284 and the detectors 271 and 272 to align the film 10. In detail, when it is determined by the detectors 271 and 272 that the film 10 deviates from the alignment area 120, the controller 260 drives only the pins 211, 221, 231, and 241 corresponding to the deviating position to align the film 10. Accordingly, by the control of the controller 260, the pins 211, 221, 231, and 241 may individually operate the alignment operation and may sequentially perform the alignment operation at short time intervals.

The panels 210, 220, 230, and 240, and the pins 211, 221, 231, and 241 have respective specific control values, and as a result, the alignment may be smoothly controlled. The specific control values may control the film 10 to be aligned in accordance with a characteristic of a long film 10 by setting an angle value other than the X-axial, Y-axial, and Z-axial (vertical directional) angle values.

The controlling method and the movement controlling the panels 210, 220, 230, and 240 and the pins 211, 221, 231, and 241 by using the controller 260, the detectors 271 and 272, and the drivers 281, 282, 283, and 284 are just exemplified, and constituent elements may be further added according to the need of those skilled in the art, and the movement or the controlling method may be modified.

For example, the movement of the panels 210, 220, 230, and 240 may be performed as follows. The first panel 210 and the third panel 230 are long side panels and may move in a vertical direction as illustrated in FIG. 4, and may align both ends of the film 10. Both ends of the film 10 may mean an upper side and a lower side of the film 10. That is, before moving, the first panel 210 and the third panel 230 are positioned on the alignment substrate 250, and after moving, the first panel 210 may ascend upwards along the first rail 212, and the third panel 230 may descend downwards along the third rail 232. Accordingly, the first panel 210 and the third panel 230 are far away from each other in opposite directions. The second panel 220 and the fourth panel 240 are short side panels and may move to the left and the right as illustrated in FIG. 4, and may align both sides of the film 10. Here, “both sides of the film” 10 refers to a right side and a left side of the film 10. Before moving, the second panel 220 and the fourth panel 240 are positioned on the alignment substrate 250, and after moving, the second panel 220 may move to the right along the second rail 222, and the fourth panel 240 may move to the left along the fourth rail 242. Accordingly, the second panel 220 and the fourth panel 240 are far away from each other in opposite directions. The first panel 210, the second panel 220, the third panel 230, and the fourth panel 240 are separated from each other in the respective directions, and then push the edge of the film 10 positioned on the stage 100 to primarily align the film 10. The movement of the panels 210, 220, 230, and 240 is just exemplified for helping the description, and may be modified according to the need of those skilled in the art.

FIG. 5 is a diagram illustrating an operational state of pins according to the first exemplary embodiment. Referring to FIG. 5, the movement of the pins 211, 221, 231, and 241 is as follows.

The pin 211 may move in the guide part 110. In detail, the pin 211 may reciprocate, and the reciprocation may be performed in the groove. For example, the reciprocation may be performed by moving the pin 211 in the Y-axial direction, as illustrated in FIG. 5. In other implementations, the pin 211 may move in an X-axial direction, or the pin 211 may move in a Z-axial direction.

When the film 10 is covered by the groove, the pin 211 pushes or strikes the film 10 to move the film 10 toward the end of the groove. The end of the groove is in contact with the alignment area 120. Accordingly, the film 10 may be eventually aligned with the alignment area 120. If the film 10 is thin, the film 10 may have an easily creased or damaged characteristic. Accordingly, according to a pushing degree or striking degree of the pin 211, the film 10 could be damaged. To reduce the likelihood of such damage, in the reciprocation, the pin 211 may move along the inside of the guide part 110 and vibrate. When the pin 211 is moved by fine vibration, the strength of pushing or striking the film 10 may be controlled by controlling the vibration. The movement of the pin 211 is just exemplified for helping the description, and may be modified according to the need of those skilled in the art.

### Second Exemplary Embodiment

In the second exemplary embodiment, an alignment body 300 exemplifies a film alignment device including a plurality of pins 311, 312, 313, and 314. A stage 100 corresponding to the alignment body 300 exemplified in the second exemplary embodiment has the same configuration and function as those exemplified in the first exemplary embodiment described above, the contents of the first exemplary embodiment are applied and the description thereof will not be repeated.

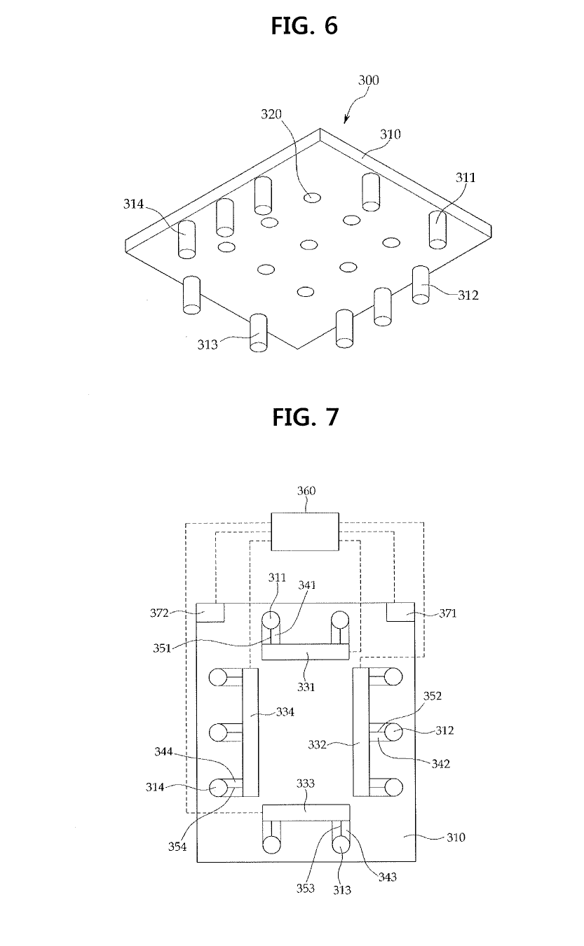

FIG. 6 is a diagram illustrating an alignment body according to a second exemplary embodiment. Referring to FIG. 6, the alignment body 300 according to the second exemplary embodiment includes an alignment substrate 310, pins 311, 312, 313, and 314, and alignment body suction holes 320.

The alignment body 300 is disposed above the stage 100, and the alignment body and the stage are spaceable apart and facing each other. An alignment operation may be carried out by the alignment body 300 including the pins 311, 312, 313, and 314.

The alignment substrate 310 may be a rectangular wide plate, and may be manufactured to have the same shape as the alignment area 120 so as to align the film 10.

A plurality of alignment body suction holes 320 may be provided in the alignment substrate 310, and may suction and lift the film 10 or press the film 10 to the film stage 100. The number and positions of the alignment body suction holes 320 are exemplified, and the number, the size, and the like of the alignment body suction holes 320 may be modified according to the need of those skilled in the art.

The pins 311, 312, 313, and 314 may be included on alignment substrate 310. In FIG. 6, a moving path of the pins 311, 312, 313, and 314 is omitted, and an appropriate moving path (not illustrated) may be provided. A plurality of first pins 311 may be disposed along a first side of the rectangular alignment substrate 310, a plurality of second pins 312 may be disposed along a second side thereof, a plurality of third pins 313 may be disposed along a third side thereof, and a plurality of fourth pins 314 may be disposed along a fourth side thereof. The pins 311, 312, 313, and 314 may be provided to move in the guide parts 110, respectively. Cross sections of the pins 311, 312, 313, and 314 may be circles, ovals, or polygons. The number and positions of the pins 311, 312, 313, and 314 are exemplified, and the number, the size, and the like of the pins 311, 312, 313, and 314 may be modified according to the need of those skilled in the art.

FIG. 7 is a diagram illustrating a control of the alignment body according to the second exemplary embodiment. Referring to FIG. 7, the alignment body 300 may further include drivers 331, 332, 333, and 334, pin moving paths 341, 342, 343, and 344, connectors 351, 352, 353, and 354, a controller 360, and detectors 371 and 372.

The drivers 331, 332, 333, and 334 drive the pins 311, 312, 313, and 314. The drivers 331, 332, 333, and 334 may be configured by a first driver 331, a second driver 332, a third driver 333, and a fourth driver 334.

The pin moving paths 341, 342, 343, and 344 provide paths on which the pins 311, 312, 313, and 314 move. The pin moving paths 341, 342, 343, and 344 may include a first pin moving path 341, a second pin moving path 342, a third pin moving path 343, and a fourth pin moving path 344.

The connectors 351, 352, 353, and 354 connect the pins 311, 312, 313, and 314 and the drivers 331, 332, 333, and 334 with each other. The connectors 351, 352, 353, and 354 may include a first connector 351, a second connector 352, a third connector 353, and a fourth connector 354.

The controller 360 controls the pins 311, 312, 313, and 314, the drivers 331, 332, 333, and 334, and the detectors 371 and 372.

The detectors 371 and 372 recognize a position of the film 10. The detectors 371 and 372 may be configured by a first detector 371 and a second detector 372.

The numbers, the layout positions, and the like of the drivers 331, 332, 333, and 334, the pin moving paths 341, 342, 343, and 344, the connectors 351, 352, 353, and 354, the controller 360, and the detectors 371 and 372 are exemplified, and the numbers, sizes, and the like of the drivers 331, 332, 333, and 334, the pin moving paths 341, 342, 343, and 344, the connectors 351, 352, 353, and 354, the controller 360, and the detectors 371 and 372 may be modified according to the desires of those skilled in the art.

A controlling method and movement of the pins 311, 312, 313, and 314 will be described as follows by using the constituent elements.

The drivers 331, 332, 333, and 334 are included in the alignment substrate 310 to drive the pins 311, 312, 313, and 314. The pins 311, 312, 313, and 314 may move by using the pin moving paths 341, 342, 343, and 344. That is, the pins 311, 312, 313, and 314 disposed along the same side of the alignment substrate 310 may use the same drivers. In detail, the first pin 311 is connected with the driver 331 through the connectors 351 and receives driving force by the driver 331 to move on the first pin moving path 341. The second pin 312, the third pin 313, and the fourth pin 314 may also move through the same process as the first pin 311.

The detectors 371 and 372 may be positioned at the edge of the alignment substrate 310, and may check whether the film 10 is accurately aligned in the alignment area 120. For example, the detectors 371 and 372 measure X-axial, Y-axial, and Z-axial lengths and angle values up to the edge of the alignment area 120 and the edge of the film 10 and compare the measured lengths and angle values with a reference value in the case of accurately aligning the film 10 to determine whether the film 10 is aligned. The values may be measured by using a sensor (not illustrated) such as a camera.

The controller 360 controls operations of the drivers 331, 332, 333, and 334 and the detectors 371 and 372 to align the film 10. In detail, when it is checked that the film 10 deviates from the alignment area 120 by the detectors 371 and 372, the controller 360 drives only the pins 311, 312, 313, and 314 corresponding to the deviating position to align the film 10. Accordingly, by the control of the controller 360, the pins 311, 312, 313, and 314 may individually operate or may sequentially perform the alignment operation at short time intervals.

The pins 311, 312, 313, and 314 have respective specific control values, and as a result, the alignment may be smoothly controlled. The specific control values may control the film 10 to be aligned in accordance with a characteristic of a long film 10 by setting an angle value other than the X-axial, Y-axial, and Z-axial (vertical direction) angle values.

The controlling method and the movement controlling the pins 311, 312, 313, and 314 by using the controller 360, the detectors 371 and 372, and the drivers 331, 332, 333, and 334 are just exemplified, and constituent elements may be further added according to the desires of those skilled in the art, and the movement or the controlling method may be modified.

Meanwhile, individual operation states and controlling methods of the pins 311, 312, 313, and 314 may be in accordance with the description provided with respect to FIG. 5 in the first exemplary embodiment.

### Third Exemplary Embodiment

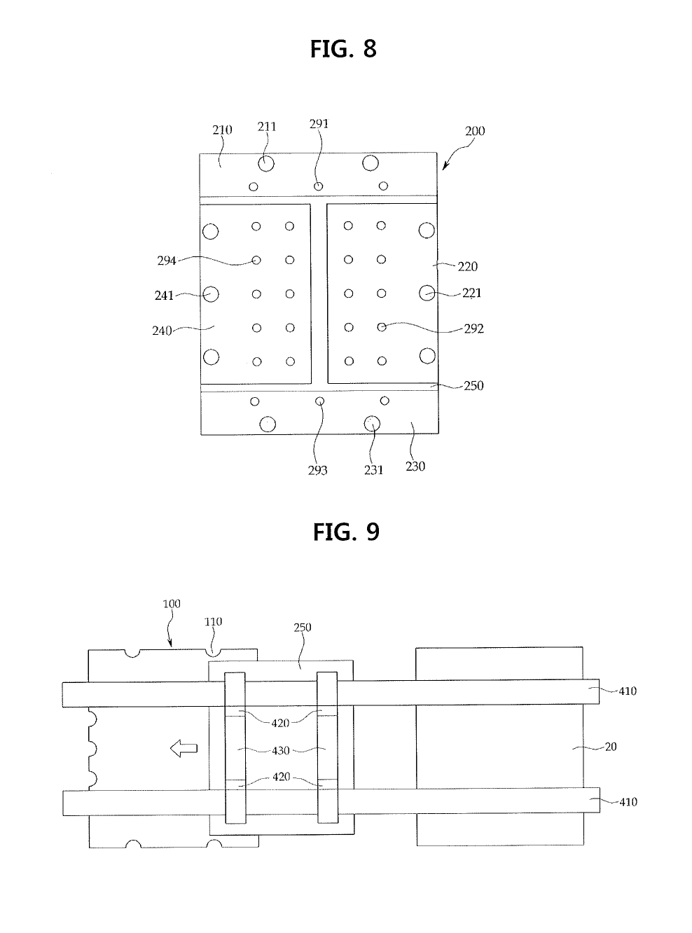

FIG. 8 is a plan view illustrating an alignment body according to a third exemplary embodiment. Referring to FIG. 8, a plurality of suction holes 291, 292, 293, and 294 may be further included in the alignment body 200.

The suction holes 291, 292, 293, and 294 may be included in the panels 210, 220, 230, and 240. A vacuum pump (not illustrated) may be connected to the suction holes 291, 292, 293, and 294. The suction holes 291, 292, 293, and 294 may suck the film 10 from a film loading table 20 to seat the film 10 on the panels 210, 220, 230, and 240, and then place the film on the stage 100. The respective suction holes 291, 292, 293, and 294 may have respective vacuum degrees of suction and thus may control so as to flatly lift the film 10 by appropriately matching the center of gravity of the film 10 and a weight applied to each portion. The number and positions of the suction holes 291, 292, 293, and 294 are exemplified, and the number, the size, and the like of the suction holes 291, 292, 293, and 294 may be modified according to the need of those skilled in the art.

FIG. 9 is a diagram illustrating a moving state of a carrying part according to the third exemplary embodiment. Referring to FIG. 9, the film alignment device according to the exemplary embodiment may further include a carrying part.

The carrying part is connected with the alignment substrate 250 and may move the alignment body 200 above the stage 100.

The carrying part may include a rail 410, a first carrying part 420, and a second carrying part 430. The rail 410 may be positioned on the stage 100 and the film loading table 20 and may be connected to the second carrying part 430.

The second carrying part 430 may be connected to the rail 410, and may straightly move the alignment body 200 from the film loading table 20 onto the stage 100.

The first carrying part 420 connects the second carrying part 430 and the alignment body 200, and may vertically move the alignment body 200.

According to an exemplary embodiment other than the above exemplary embodiments, the film alignment device may align other target materials such as a sheet other than the film.

That is, the alignment device may include a stage on which an alignment target sheet is disposed and where a guide part is disposed at the side, and an alignment body which is disposed above the stage to be spaced apart from the stage while facing each other and includes pins disposed to move from the guide part. The alignment target sheet may be a film, and particularly, the film may have flexibility. An alignment area may be defined on the stage. When the sheet deviates from the alignment area, the sheet may be aligned by driving pins corresponding to the deviating position. A detector that recognizes the position of the sheet may be included in the alignment body. In addition, constituent elements and functions illustrated in the film alignment device may be applied.

As described above, the exemplary embodiments of the film alignment device are just exemplified, and those skilled in the art can understand that the scope may include various modifications and equivalent embodiments therefrom.

By way of summation and review, a size of each layer included in an organic light emitting display device is small. Accordingly, fine operations are required. When the fine operations are performed, alignment work of a substrate, a laminate, a film, and the like greatly influences performance of the organic light emitting display device. In the case where the substrate, the laminate, the film, and the like are flexible, the film or the like may be easily creased or waved, and alignment may be more difficult. Further, when a flexible film and the like are brought from a loading box of the film and the like to a worktable where the alignment is performed, there possibility that the film may be creased or not aligned on the worktable and thus a side of the film may be lifted.

In contrast, embodiments provide a film alignment device that may easily align a film-shaped laminate. Embodiments may provide a film alignment device that easily aligns a film that is made of a material that is easily creased or waved due to flexibility. According to embodiments, it may be possible to finely align a thin and light film, thereby preventing or minimizing damage to the film during an alignment process, reducing a defect ratio occurring during a laminating process, and shortening a processing time.

From the foregoing, it will be appreciated that various embodiments have been described herein for purposes of illustration, and that various modifications may be made without departing from the scope and spirit thereof. Accordingly, the various embodiments disclosed herein are not intended to be limiting, with the true scope and spirit being indicated by the following claims.

What is claimed is:

1. A film alignment device, comprising:
a stage on which a film is to be disposed; and
an alignment body above the stage, the alignment body and the stage being spaceable apart from and facing each other,
wherein:
the stage includes a plurality of guide parts at sides thereof, and
the alignment body includes a plurality of pins configured to move in the guide parts to align the film.

2. The film alignment device of claim 1, wherein the guide parts have groove shapes that are spaced apart from each other at the side of the stage.

3. The film alignment device of claim 1, wherein:
an alignment area is defined in the stage, and
ends of the grooves correspond to the alignment area.

4. The film alignment device of claim 1, wherein the cross section of the pins is a circle, an oval, or a polygon.

5. The film alignment device of claim 1, wherein:
the alignment body includes a movable panel part, and
the plurality of pins is included in the movable panel part.

6. The film alignment device of claim 5, wherein the movable panel part includes a plurality of suction holes.

7. The film alignment device of claim 5, wherein the alignment body includes drivers for driving the movable panel part.

8. The film alignment device of claim 1, wherein the alignment body includes drivers for driving the pins.

9. The film alignment device of claim 1, wherein the alignment body includes a detector that recognizes a position of the film.

10. The film alignment device of claim 1, wherein the alignment body includes a controller that controls the pins.

11. The film alignment device of claim 1, wherein the pins reciprocate.

12. The film alignment device of claim 11, wherein the pins reciprocate such that the pins move and vibrate in the guide parts.

13. The film alignment device of claim 1, wherein the alignment body includes a plurality of suction holes.

14. The film alignment device of claim 1, wherein the stage includes a plurality of suction holes to fix the film.

15. An alignment device, comprising:
a stage on which a sheet to be aligned is disposed, the stage including guide parts at sides thereof; and
an alignment body above the stage, the alignment body and the stage being spaceable apart from and facing each other, and the alignment body including pins that move in the guide parts.

16. The alignment device of claim 15, wherein the sheet to be aligned is a film.

17. The alignment device of claim 16, wherein the film has flexibility.

18. The alignment device of claim 15, wherein an alignment area is defined in the stage.

19. The alignment device of claim 18, wherein the alignment device is configured such that when the sheet deviates from the alignment area, the sheet is aligned by driving pins corresponding to a position of deviation.

20. The alignment device of claim 15, wherein the alignment body includes a detector that recognizes a position of the sheet.
